(19) United States
(12) Patent Application Publication
(10) Pub. No.: US 2013/0033881 A1
(43) Pub. Date: Feb. 7, 2013

(54) LIGHTING DEVICE

(71) Applicants: Noriaki Terazawa, Osaka-shi (JP); Yasuki Tsutsumi, Osaka-shi (JP)

(72) Inventors: Noriaki Terazawa, Osaka-shi (JP); Yasuki Tsutsumi, Osaka-shi (JP)

(73) Assignee: SHARP KABUSHIKI KAISHA, Osaka-shi, Osaka (JP)

(21) Appl. No.: 13/642,133

(22) PCT Filed: Mar. 28, 2011
(86) PCT No.: PCT/JP2011/057524

§ 371 Date: Oct. 19, 2012

(30) Foreign Application Priority Data
Apr. 20, 2010 (JP) 2010-096995

(51) Int. Cl. F21V 23/00; F21V 29/00

(52) U.S. Cl. 362/382

(57) ABSTRACT

A lighting device includes: a light source module; a heat dissipation section accommodating a power-source circuit section for driving the light source module; and a base provided on a part of the heat dissipation section, wherein a cavity is formed in each of the heat dissipation section and the base, and a gas layer exists around circuit components such as a power-source circuit component and a heat generation component of the power-source circuit section, and at least the cavity of the base is filled with a thermosetting resin.

### TECHNICAL FIELD

The present invention relates to a bulb-type lighting device comprising a base.

### BACKGROUND ART

A conventional incandescent light bulb comprises a base having a bottomed cylindrical shape, and the base includes: a terminal of one pole having a threaded cylindrical portion to be screwed to a bulb socket connected to an external power source; and a terminal of the other pole projecting at a bottom surface of the base.

The terminal of one pole and the terminal of the other pole of the base are electrically connected via electric wires or the like to a drive circuit section for driving a light source. A fluorescent lamp device disclosed in Patent Document 1 comprises: a device main body 501 including a base 502, a case 503 attached to the base 502 and having a trumpet-like opening, a lighting circuit (drive circuit section) 504 accommodated in the case 503, and a fluorescent lamp 509 electrically connected to the lighting circuit 504; and a globe 510 coupled to the device main body 501 and surrounding the fluorescent lamp 509 (see FIG. 1). In the fluorescent lamp device, a space surrounded by a circuit board 505 on which the lighting circuit 504 is mounted and the case 503, and a cavity formed in the base 502 are both filled with a resin mold material 506.

### PRIOR ART DOCUMENT

Patent Document

[Patent Document 1] Japanese Patent Application Laid-Open No. 57-50762 (1982)

### SUMMARY OF THE INVENTION

### Problems to be Solved by the Invention

However, when the space and cavity are filled with the resin mold material 506 so that circuit components included in the lighting circuit 504 mounted on the circuit board 505 are covered as in the fluorescent lamp device disclosed in Patent Document 1, there is a difference between coefficients of thermal expansion of the resin and circuit components or the like; hence, when the resin is cooled and hardened, stress is applied to the circuit components or electric wires and the like connected to the circuit components in accordance with the difference between the coefficients of thermal expansion. Therefore, due to the applied stress, the circuit component might be broken, or disconnection or the like might occur in the electric wire connected to the circuit component. Further, when the resin mold material is removed from the space surrounded by the circuit board 505 on which the lighting circuit 504 is mounted and the case 503, and the cavity formed in the base 502 in view of the above problem, there arises a problem that when the lighting device is dropped, the base is deformed and cannot be screwed to a bulb socket, or the electric wire or the like in the base is disconnected and power cannot be supplied to the drive circuit section from an external power source.

The present invention has been made in view of the above-described circumstances, and its object is to provide a lighting device capable of preventing disconnection or the like of an electric wire in a drive circuit section and capable of preventing breakage of a component when the lighting device is dropped.

### MEANS FOR SOLVING THE PROBLEMS

A lighting device according to the present invention is a lighting device comprising: a light source; a main body accommodating a drive circuit section for driving the light source; and a base provided on one end side of the main body, wherein a cavity is formed in each of the main body and the base, and at least the cavity of the base is filled with a resin so that a gas layer exists

In the present invention, the cavity is formed in each of: the main body accommodating the drive circuit section for driving the light source; and the base provided on one end side of the main body, and at least the cavity of the base is filled with the resin. The cavity of the base is filled with the resin, thus increasing the strength of the base compared with a case where the cavity of the base is filled with no resin. Therefore, for example, in the event that the lighting device is dropped by mistake, deformation of the base can be reduced. Further, the inside of the base is filled with the resin, and thereby the resin can retain a connection component, such as an electric wire connected to the base and therefore, it is possible to prevent disconnection of the electric wire and the like when impact force is applied to the base. Furthermore, the gas layer such as air exists around the circuit component of the drive circuit section accommodated in the cavity of the main body, and the circuit component is not covered with the resin. Accordingly, it is possible to prevent breakage of the circuit component or disconnection or the like of the electric wire connected to the circuit component, caused by stress produced in accordance with a difference between coefficients of thermal expansion of the resin and the circuit component.

A lighting device according to the present invention is characterized in that the resin is a hardening resin.

In the present invention, the hardening resin is used as the resin with which the inside of the base is filled; thus, the inside of the base can be easily filled with the resin so that there is no gap in the base. In addition, the hardening resin is appropriately selected, thereby sufficiently increasing the strength of the base. Besides, the connection component such as the electric wire connected to the base can be firmly retained by the hardening resin.

A lighting device according to the present invention is characterized by further comprising an insulator for electrically insulating the main body and the base from each other, wherein a reinforcement member is provided in the insulator.

In the present invention, the lighting device further comprises the insulator for electrically insulating the main body and the base from each other, and the reinforcement member is provided in the insulator. Since the insulator is provided with the reinforcement member, it is possible to prevent deformation of the insulator when a force is applied to the insulator. Furthermore, the reinforcement member is provided in the insulator. The reinforcement member has an appropriate shape; thus, even when heat is generated due to failure or the like of the circuit component accommodated in the lighting device, it is difficult for the heat emitted from the circuit component to transmit to the insulator, thereby preventing smoking or ignition caused by an increase in temperature of the insulator.

A lighting device according to the present invention is characterized in that a retaining section for retaining the reinforcement member projects from an inner surface of the insulator.

In the present invention, the retaining section for retaining the reinforcement member projects from the inner surface of the insulator. Hence, the retaining section is appropriately provided, thereby allowing a gas layer such as air to be interposed between the insulator and the reinforcement member. The interposition of the gas layer allows the gas layer to function as a heat insulator, thereby making it difficult for heat to transmit from the reinforcement member to the insulator. As a result, when heat is generated due to failure or the like of the circuit component accommodated in the lighting device, the amount of heat transmitted to the insulator can be reduced, and smoking or ignition caused by an increase in temperature of the insulator can be prevented with more reliability.

A lighting device according to the present invention is characterized in that the drive circuit section comprises a board on which the circuit component is mounted, and the insulator and the reinforcement member are each provided with an engagement concave for engaging with a part of the board.

In the present invention, the insulator and the reinforcement member are each provided with the engagement concave for engaging with a part of the board on which the circuit component is mounted. The engagement concaves provided at the insulator and the reinforcement member are engaged with the board, thereby allowing the reinforcement member to be retained in an immovable manner between the insulator and the board. As a result, when the lighting device is moved, the reinforcement member does not move in the lighting device and thus a user will not feel a sense of discomfort.

### EFFECTS OF THE INVENTION

According to the present invention, it is possible to prevent disconnection or the like of an electric wire in a drive circuit section and to prevent breakage of a component when the lighting device is dropped.

### BRIEF DESCRIPTION OF THE DRAWINGS

FIG. 1 is a partial cross-sectional view of a lighting device according to a conventional art.

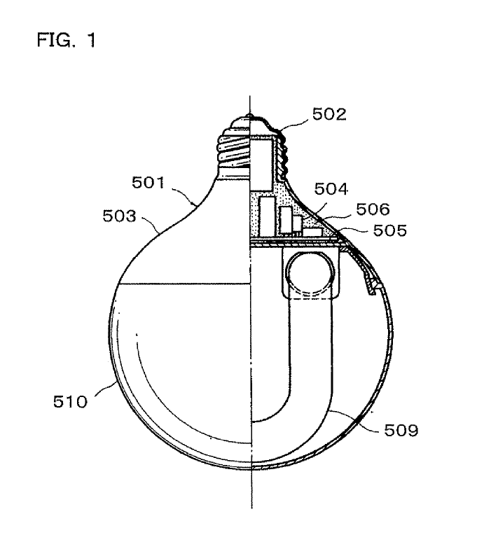

FIG. 2 is a schematic external perspective view of a lighting device according to an embodiment of the present invention.

FIG. 3 is a schematic exploded perspective view of the lighting device according to the present embodiment.

FIG. 4 is a schematic longitudinal cross-sectional view illustrating main parts of the lighting device according to the present embodiment.

FIG. 5 is a plan view illustrating main parts of the lighting device according to the present embodiment, including an insulation case and a base thereof.

FIG. 6 is a schematic cross-sectional view taken along the line V-V of FIG. 5.

### MODE FOR CARRYING OUT THE INVENTION

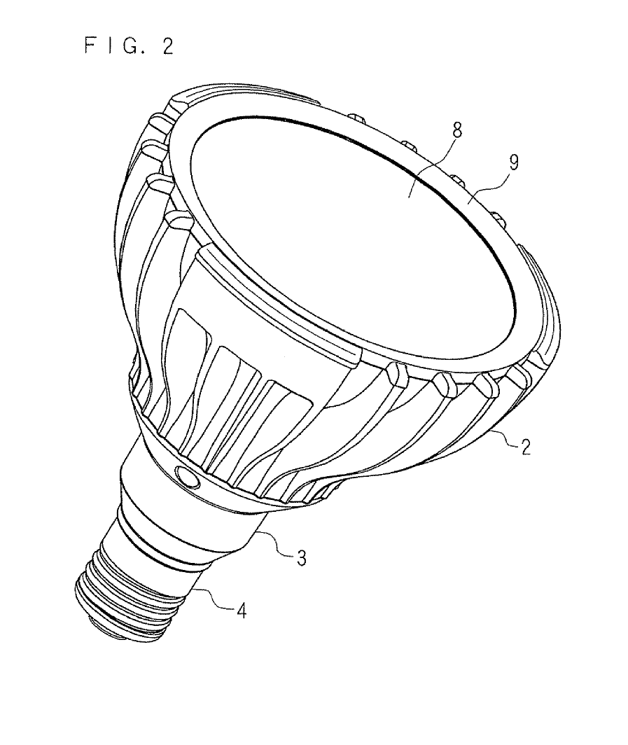

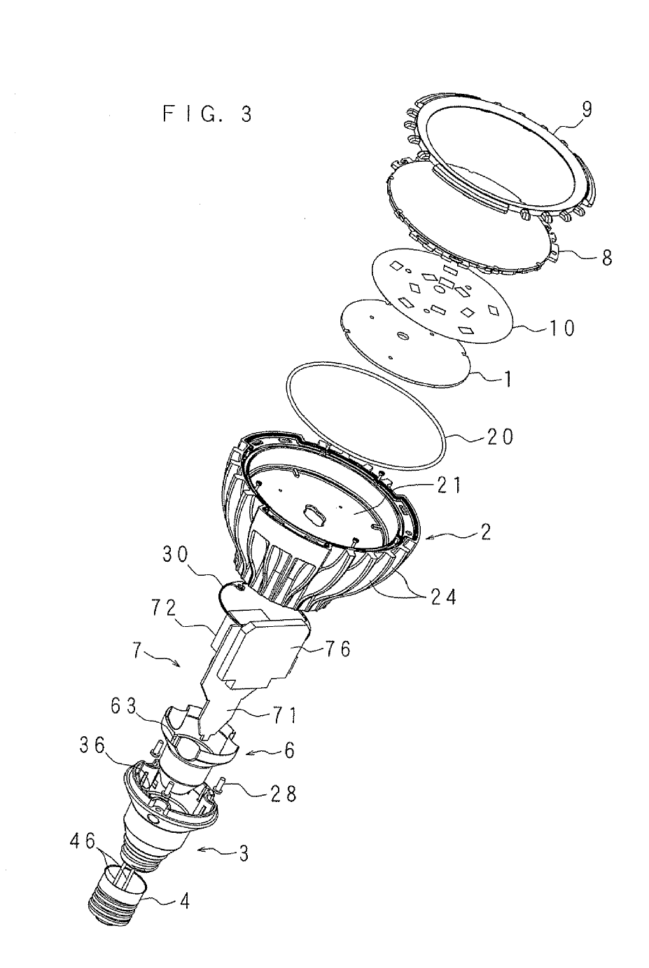

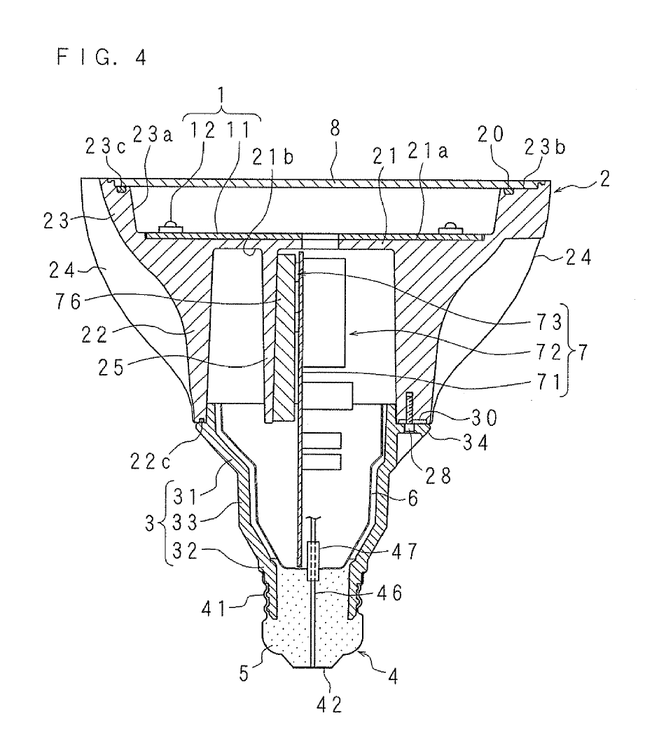

Hereinafter, referring to the drawings illustrating an embodiment of the present invention, the present invention will be described in detail by using, as an example, a so-called PAR (Parabolic Aluminized Reflector)-type lighting device which is a kind of bulb-type lighting device and has an outer shape with a parabolic curved surface. FIG. 2 is a schematic external perspective view of a lighting device according to an embodiment of the present invention. FIG. 3 is a schematic exploded perspective view of the lighting device according to the present embodiment. FIG. 4 is a schematic longitudinal cross-sectional view illustrating main parts of the lighting device according to the present embodiment.

The reference numeral “1” in FIGS. 3 and 4 represents a light source module serving as a light source. As illustrated in FIG. 4, the light source module 1 includes a plurality of light-emitting diodes (hereinafter referred to as “LEDs”) 12 mounted on one surface of a disk-shaped LED board 11. The LEDs 12 are surface-mounted LEDs, for example. In the present embodiment, the five LEDs 12 are provided annularly along a peripheral edge of the one surface of the LED board 11, and the other five LEDs 12 are provided inside the annularly-provided LEDs 12 so as to be substantially concentric therewith. The inner and outer LEDs are arranged alternately in a circumferential direction, and the inner five LEDs and the outer five LEDs are located substantially at equal intervals. Note that in FIG. 3, the illustration of the LEDs is omitted.

A reflection sheet 10 having a diameter substantially equal to that of the LED board 11 is attached to the one surface of the LED board 11 (i.e., the surface on which the LEDs 12 are mounted). The reflection sheet 10 is provided with rectangular holes slightly larger than planar shapes of the LEDs 12 so that the rectangular holes are in conformity with the LEDs 12. The reflection sheet 10 is made of a material having high optical reflectivity; for example, the reflection sheet 10 is made of a polyethylene terephthalate (PET) film. Thus, light emitted from the LEDs 12 will not be absorbed into the LED board 11 but will be reflected by a reflection surface of the reflection sheet 10, thereby preventing a reduction in the amount of light emitted from the light source module 1 to outside.

The light source module 1 is attached to a heat dissipation section 2 for dissipating heat emitted from the light source module 1. The heat dissipation section 2 functions as a main body that accommodates a drive circuit section for driving the light source module 1. The heat dissipation section 2 is made of metal such as aluminum, for example. The heat dissipation section 2 includes a disk-shaped light-source retaining section 21 for retaining the light source module 1. The other surface of the LED board 11 (i.e., the surface opposite to the surface on which the LEDs 12 are mounted) of the light source module 1 is attached to one surface 21a of the light-source retaining section 21. Note that a heat conduction sheet or grease is preferably interposed between the light source module 1 and the light-source retaining section 21. The light-source retaining section 21 also functions as a heat transmission section for transmitting heat emitted from the LEDs 12 to other parts of the heat dissipation section 2.

On the other surface 21b of the light-source retaining section 21, a cylindrical heat dissipation cylinder 22 is vertically provided so as to be concentric with the light-source retaining section 21. An end of the heat dissipation cylinder 22 has a plane parallel to the one surface 21a of the light-source retaining section 21, and is provided with an annular groove 22c concentric with the heat dissipation cylinder 22. An annular seal member 30 is fitted into the annular groove 22c. The seal member 30 is provided with a fixation section having three screw holes arranged in its circumferential direction.

On the one surface 21a of the light-source retaining section 21, a flattened-cylinder-shaped reflection section 23 is vertically provided so as to be concentric with the light-source retaining section 21. An inner surface 23a of the reflection section 23 is preferably mirror-finished. By applying mirror finishing, light emitted from the LEDs 12 and incident upon the inner surface 23a of the reflection section 23 is reflected by the inner surface 23a and is emitted in a direction along a light emission direction of the LEDs 12. Thus, light utilization efficiency of the entire lighting device, i.e., a so-called “device efficiency”, can be improved.

At an inner edge of an end of the reflection section 23, an attachment surface 23b for attaching a light-transmitting plate described later is formed. The attachment surface 23b is provided with an annular groove 23c. An annular gasket 20 is fitted into the annular groove 23c. The heat dissipation section 2 and the light-transmitting plate can closely contact each other by the gasket 20, thereby preventing intrusion of foreign substance such as water drop into a cavity defined by the reflection section 23 and the light-transmitting plate. The above-described light source module 1 is accommodated in the cavity defined by the reflection section 23 of the heat dissipation section 2 and the light-transmitting plate.

The heat dissipation cylinder 22 and the reflection section 23 are formed so that outer peripheral surfaces thereof are smooth curved surfaces whose diameters increase from the heat dissipation cylinder 22 toward the reflection section 23. On the outer peripheral surfaces of the heat dissipation cylinder 22 and the reflection section 23, a plurality of protrusive fins 24 projecting radially outward along a longitudinal direction are arranged substantially over the entire length of the heat dissipation section 2 substantially at equal intervals in its circumferential direction.

In the heat dissipation cylinder 22 at the other surface 21b of the light-source retaining section 21, a rectangular plate-shaped heat transmission plate 25 for transmitting heat emitted from a power-source circuit section described later to other parts of the heat dissipation section 2 is vertically provided. Furthermore, in the heat dissipation cylinder 22, a sandwiching section (not illustrated) for sandwiching a power-source board of the power-source circuit section described later is provided so as to be in parallel with the heat transmission plate 25 at an appropriate distance therefrom. Note that the light-source retaining section 21, the heat dissipation cylinder 22, the reflection section 23, the fins 24 and the heat transmission plate 25 are provided as one body, and the heat dissipation section 2 functions as a retainer for retaining the light source and as an outer covering for the lighting device.

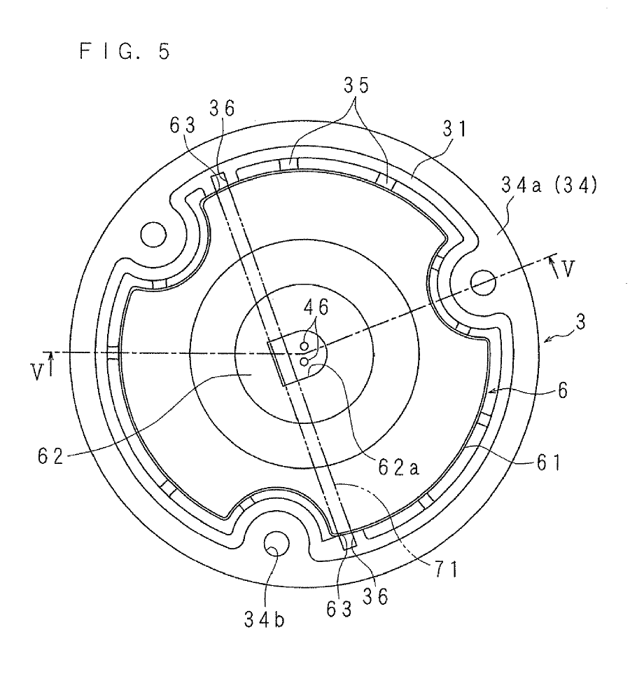

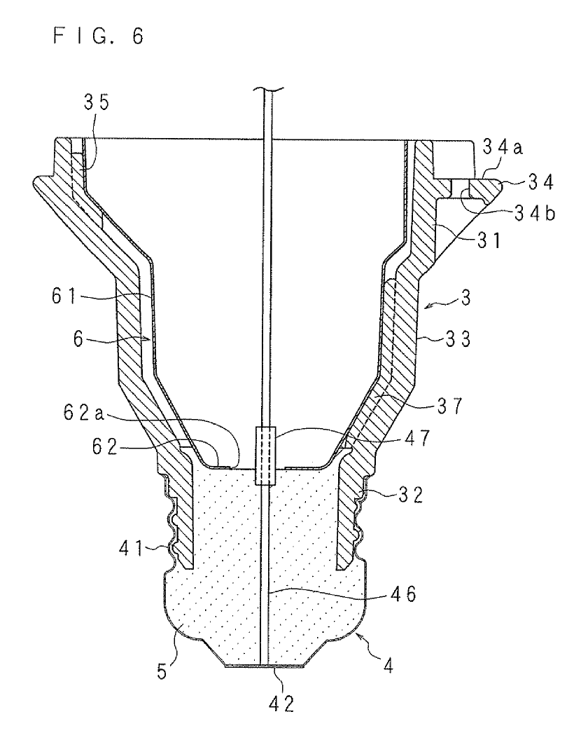

On a heat dissipation cylinder 22 side of the heat dissipation section 2 (i.e., on one end side of the heat dissipation section 2), a base 4, through which power is supplied from an external power source to the light source module 1 serving as the light source, is provided via a cylindrical insulation case 3 serving as an insulator. In other words, the base 4 is provided via the insulation case 3 serving as the insulator to the heat dissipation section 2, serving as the main body. FIG. 5 is a plan view illustrating main parts of the lighting device according to the present embodiment, including the insulation case 3 and the base 4. FIG. 6 is a schematic cross-sectional view taken along the line V-V of FIG. 5.

The insulation case 3 includes: a cylindrical heat-dissipation-section retaining cylinder 31 for retaining the heat dissipation section 2; a cylindrical base retaining cylinder 32 for retaining the base 4; and a connection section 33 through which the heat-dissipation-section retaining cylinder 31 and the base retaining cylinder 32 are connected to each other. The heat-dissipation-section retaining cylinder 31, the base retaining cylinder 32 and the connection section 33 are made of an electrical insulating material such as a resin, for example, and are provided as one body.

The heat-dissipation-section retaining cylinder 31 includes: an annular protrusive portion fitted into the heat dissipation cylinder 22 of the heat dissipation section 2; and a flange portion 34 provided around the protrusive portion and having an abutment surface 34a against which the end of the heat dissipation cylinder 22 abuts. The flange portion 34 is provided with three screw holes 34b substantially at equal intervals in its circumferential direction. The screw holes of the seal member 30 mentioned above are provided in conformity with the screw holes 34b of the flange portion 34. An outer peripheral surface of the base retaining cylinder 32 is threaded for screwing the base 4.

The heat-dissipation-section retaining cylinder 31 is provided at its inner peripheral surface with a plurality of ribs 35, each serving as a retaining section for retaining a reinforcement member described later, in such a manner that the ribs 35 are spaced at appropriate distances in a circumferential direction as illustrated in FIG. 5. As illustrated in FIG. 6, the ribs 35 are each formed across an appropriate length along a longitudinal direction of the insulation case 3.

Further, as illustrated in FIG. 5, the heat-dissipation-section retaining cylinder 31 is provided at its end with two engagement concaves 36 for engaging with a part of the power-source board. Each engagement concave 36 projects inward from an inner peripheral surface of the heat-dissipation-section retaining cylinder 31, and includes two parallel plate portions spaced at an appropriate length (i.e., a length substantially equal to the thickness of the sandwiched power-source board). The two engagement concaves 36 are provided at positions symmetrical with respect to a plane including a center line of the insulation case 3.

Similarly to the heat-dissipation-section retaining cylinder 31, the connection section 33 is provided at its inner peripheral surface with a plurality of ribs 37, each serving as a retaining section for retaining the reinforcement member described later, in such a manner that the ribs 37 are spaced at appropriate distances in a circumferential direction. As illustrated in FIG. 6, the ribs 37 are each formed across an appropriate length along the longitudinal direction of the insulation case 3.

The base 4 has a bottomed cylindrical shape and includes: a terminal 41 of one pole having a threaded cylindrical portion for screwing to a bulb socket; and a terminal 42 of the other pole projecting at a bottom surface of the base 4. The terminal 41 of one pole and the terminal 42 of the other pole are electrically insulated.

Note that an outer shape of the cylindrical portion of the base 4 is the same shape as an E26 screw base defined in JIS (Japanese Industrial Standards), for example. One ends of electric wires 46 are fixed to the terminal 41 of one pole and the terminal 42 of the other pole of the base 4 by soldering or the like. The two electric wires 46 are each covered with a protection tube 47 across an appropriate length. The protection tube 47 is made of glass, for example.

The base retaining cylinder 32 of the insulation case 3 is inserted into and fixed to the base 4, and thus the base 4 is integrated with the insulation case 3. Furthermore, a metal case 6 serving as the reinforcement member is retained in the insulation case 3.

The metal case 6 has a bottomed cylindrical shape and is made of iron, for example. The metal case 6 includes: a cylindrical portion 61 formed along the shape of the insulation case 3; and a bottom portion 62 provided at one end of the cylindrical portion 61. The cylindrical portion 61 is formed slightly smaller than the insulation case 3 so that the cylindrical portion 61 and an inner peripheral surface of the insulation case 3 are spaced at an appropriate distance (e.g., about 3 mm) and a gas layer such as air is interposed between the cylindrical portion 61 and the insulation case 3. Note that heights of projecting portions of the above-mentioned ribs 35 and 37 are appropriately set so as to ensure a gap between the inner peripheral surface of the insulation case 3 and an outer peripheral surface of the cylindrical portion 61 of the metal case 6 (i.e., a thickness of the gas layer such as air therebetween). The bottom portion 62 has a pentagonal hole 62a through which the electric wires 46 are inserted, and the bottom portion 62 has a disk-like shape. As illustrated in FIG. 6, the above-mentioned protection tube 47 is provided at a position corresponding to the hole 62a of the bottom portion 62. The protection tube 47 is provided at the position substantially coinciding with the bottom portion 62 with respect to a longitudinal direction of the metal case 6, thus preventing the electric wires 46 from being directly brought into contact with a peripheral edge of the hole 62a of the bottom portion 62 of the metal case 6. Hence, the protection tube 47 can protect the electric wires 46 so as to prevent damage of the electric wires 46.

Further, as illustrated in FIG. 5, at an end of the cylindrical portion 61 of the metal case 6, two engagement concaves 63 are formed at positions corresponding to those of the engagement concaves 36 provided at the end of the heat-dissipation-section retaining cylinder 31. Each engagement concave 63 is a rectangular notched portion formed by longitudinally notching the end of the cylindrical portion 61 along an appropriate length. The two engagement concaves 63 are provided at symmetrical positions with respect to a plane including a center line of the metal case 6. Note that the engagement concaves 36 and 63 may be formed into any shapes as long as they are engaged with the power-source board; hence, the shapes of the engagement concaves 36 and 63 are not limited to those described in the present embodiment.

The inside of the base 4 is filled with a thermosetting resin 5 which is a resin (hardening resin) serving as a reinforcement material for reinforcing the base 4. More specifically, as illustrated in FIG. 6, a cavity surrounded by the base 4, the base retaining cylinder 32 of the insulation case 3 and the bottom portion 62 of the metal case 6 is filled with the thermosetting resin 5. Note that as illustrated in FIG. 6, the protection tube 47 is partially embedded in the thermosetting resin 5. As the thermosetting resin 5, for example, a resin in which two liquids of polyol and isocyanate are mixed is used. The thermosetting resin 5 has fluidity at the time of filling, and is solidified and hardened over time. The thermosetting resin 5 has predetermined strength in the solidified state; hence, the strength of the base 4 can be increased compared with a case where the inside of the base 4 is not filled with the thermosetting resin 5.

Further, the thermosetting resin 5 can firmly retain the electric wires 46 connected to the terminal 41 of one pole and the terminal 42 of the other pole of the base 4, in the solidified state.

The heat-dissipation-section retaining cylinder 31 of the insulation case 3 is inserted into the heat dissipation cylinder 22 of the heat dissipation section 2 and is fixed by screws 28; thus, the insulation case 3 is integrated with the heat dissipation section 2. More specifically, the seal member 30 is fitted into the groove 22c provided at the end of the heat dissipation cylinder 22 of the heat dissipation section 2 in such a manner that the screw holes of the seal member 30 correspond to the screw holes provided at the end of the heat dissipation cylinder 22; in addition, the flange portion 34 of the heat-dissipation-section retaining cylinder 31 of the insulation case 3 is abutted against the heat dissipation cylinder 22 of the heat dissipation section 2 in such a manner that the screw holes 34b provided at the flange portion 34 of the heat-dissipation-section retaining cylinder 31 correspond to the screw holes of the heat dissipation cylinder 22 and the seal member 30. In this state, the screws 28 are screwed into the screw holes, and thus the insulation case 3 is fixed to the heat dissipation section 2. The heat dissipation section 2 and the insulation case 3 can closely contact each other via the seal member 30, thereby preventing intrusion of foreign substance such as water drop into a cavity defined by the heat dissipation section 2 and the insulation case 3.

The cavity, defined by the heat dissipation section 2 and the insulation case 3 integrated with each other in this manner, accommodates a power-source circuit section 7 which supplies power of predetermined voltage and current to the light source module 1 through an electric wire and serves as the drive circuit section for driving the light source module 1. The power-source circuit section 7 includes: a power-source board 71 having a shape conforming to a longitudinal cross-sectional shape of the cavity accommodating the power-source circuit section 7; and a plurality of power-source circuit components mounted on the power-source board 71. The power-source circuit components mounted in a distributed manner on both surfaces of the power-source board 71 include: a bridge diode for full-wave rectification of an alternating current supplied from an external AC power source; a transformer for transforming the rectified power source voltage to a predetermined voltage; a diode connected to primary and secondary sides of the transformer; and an IC. Note that as the power-source board 71, a glass epoxy board or paper phenol board, for example, is used.

A plurality of power-source circuit components 72 are mounted on one surface of the power-source board 71 of the power-source circuit section 7, and a heat generation component 73 is mounted on the other surface of the power-source board 71. Compared with the power-source circuit components 72 mounted on the one surface of the power-source board 71, the heat generation component 73 is a power-source circuit component having a relatively large amount of heat generation resulting from the supplied current.

With respect to the power-source circuit section 7, as indicated by the chain double-dashed lines in FIG. 5, a part of the power-source board 71 is engaged with: the engagement concaves 36 provided at the end of the heat-dissipation-section retaining cylinder 31 of the insulation case 3; and the engagement concaves 63 provided at the end of the cylindrical portion 61 of the metal case 6. Further, other part of the power-source board 71 is engaged with the sandwiching portion provided in the heat dissipation cylinder 22 of the heat dissipation section 2. Both of the part and the other part of the power-source board 71 are each engaged with the associated engagement concaves or the sandwiching portion so that the other surface of the power-source board 71 (i.e., the surface on which the heat generation component 73 is mounted) faces the heat transmission plate 25 of the heat dissipation section 2. Thus, the power-source circuit section 7 is retained in the cavity defined by the heat dissipation section 2 and the insulation case 3. As illustrated in FIG. 4, in the retained state, the power-source circuit section 7 is located in the cavity defined by the heat dissipation section 2 and the metal case 6, and a gas layer exists around the power-source circuit components 72 and the heat generation component 73 serving as circuit components of the power-source circuit section 7; as a result, the circuit components of the power-source circuit section 7 are not covered with the above-mentioned thermosetting resin 5.

Furthermore, the power-source board 71 of the power-source circuit section 7 also functions as a fixing member for fixing the metal case 6 to the insulation case 3 in an immovable manner.

A rectangular-plate-shaped heat conduction sheet 76 is interposed between the other surface of the power-source board 71 and the heat transmission plate 25. A size and a location of the heat conduction sheet 76 are appropriately determined in accordance with a location of the heat generation component 73. As the heat conduction sheet 76, a good heat conductor having insulation property is used; for example, a heat conduction sheet made of low hardness silicone rubber having flame resistance is used. Heat emitted from the power-source circuit section 7 or particularly the heat generation component 73 is transmitted to the heat transmission plate 25 via the heat conduction sheet 76.

The power-source circuit section 7 is connected with the other end of each electric wire 46 whose one end is connected to the terminal 41 of one pole or terminal 42 of the other pole of the base 4, and thus the power-source circuit section 7 is electrically connected to the base 4. Moreover, the power-source circuit section 7 is electrically connected to the light source module 1 by a connector via an electric wire (not illustrated). Note that the power-source circuit section 7 may be electrically connected to the light source module 1 by using a pin plug instead of using an electric wire.

A disk-shaped light-transmitting plate 8, which covers a region corresponding to the light emission direction of the light source module 1 and transmits light emitted from the LEDs 12 while dispersing the light, is attached to the attachment surface 23b of the reflection section 23 of the heat dissipation section 2. The light-transmitting plate 8 is provided at its outer edge with a plurality of engagement portions to be engaged with engagement portions provided at an end of the reflection section 23 of the heat dissipation section 2 and/or a ring cover described later so that the plurality of engagement portions are spaced at appropriate distances in a circumferential direction. The outer edge of the light-transmitting plate 8 is abutted against the attachment surface 23b of the reflection section 23 of the heat dissipation section 2, and is fixed to the heat dissipation section 2 by screws or the like. Note that the light-transmitting plate 8 is made of, for example, a milky polycarbonate resin which is excellent in impact resistance and heat resistance and to which a dispersing agent is appropriately added.

A ring cover 9 is attached to the light-transmitting plate 8. The ring cover 9 has an annular shape with a diameter approximately equal to that of the light-transmitting plate 8, and protrusions are provided at an outer edge of the ring cover 9 in conformity with the shapes of the fins 24 of the heat dissipation section 2. Note that the protrusions are provided with the engagement portions to be engaged with the engagement portions of the light-transmitting plate 8.

The lighting device formed in an integrated manner as described above is connected to a commercial AC power source once the base 4 is screwed into a bulb socket. In this state, when power is turned on, an alternating current is supplied to the power-source circuit section 7 via the base 4, and a direct current rectified by the power-source circuit section 7 is supplied to the light source module 1, thereby lighting the LEDs 12.

With the lighting of the LEDs 12, heat is generated mainly by the LEDs 12 and the power-source circuit section 7. Heat emitted from the LEDs 12 is transmitted through the light-source retaining section 21 to other parts of the heat dissipation section 2, and is dissipated to air existing outside the lighting device from the other parts of the heat dissipation section 2 (mainly from the fins 24). On the other hand, heat emitted from the power-source circuit section 7 or particularly heat emitted from the heat generation component 73 is transmitted through the heat transmission plate 25 to other parts of the heat dissipation section 2, and is dissipated to air existing outside the lighting device from the other parts of the heat dissipation section 2 (mainly from the fins 24).

The lighting device according to the present embodiment described above is a PAR-type lighting device and is formed so as to obtain intensity corresponding to that of a 90-W incandescent light bulb, for example. When an amount of light is increased in order to obtain high intensity in this manner, an amount of heat generated by the LEDs 12 and the power-source circuit section 7 will be increased. It is necessary to increase a size of the heat dissipation section 2 in accordance with the amount of heat generation, and the overall weight of the resulting lighting device will be increased in accordance with an increase in the desired intensity. When the overall weight of the lighting device is increased, a force is exerted on the lighting device in accordance with its weight in the event that the lighting device is dropped by mistake, for example. Hence, when the inside of the base is kept hollow, there might occur a problem that the base is deformed and cannot be screwed into a bulb socket, or the electric wire or the like provided in the base is disconnected and power cannot be supplied from the external power source to the power-source circuit section.

In the lighting device according to the present embodiment, the inside of the base 4 is filled with the thermosetting resin 5 which is a resin serving as the reinforcement material for reinforcing the base 4, thereby increasing the strength of the base 4 compared with the case where the inside of the base 4 is filled with no resin. Thus, even in the event that the lighting device is dropped by mistake, deformation of the base 4 can be reduced. Further, the inside of the base 4 is filled with the thermosetting resin 5, thereby the thermosetting resin 5 firmly retains connection components such as the electric wires 46 connected to the base 4, and therefore, it is possible to prevent disconnection of the electric wires 46 or the like, which is caused by impact force applied to the base 4 when the lighting device is dropped.

Furthermore, the inside of the base 4 is filled with the thermosetting resin 5 in such a manner that the gas layer such as air exists around the circuit components such as the power-source circuit components 72 and the heat generation component 73 accommodated in the lighting device, and therefore, the circuit components are not covered with the thermosetting resin 5. There is a difference between coefficients of thermal expansion of the thermosetting resin 5 and the circuit components. However, the circuit components are not covered with the thermosetting resin 5; hence, when the thermosetting resin 5 is cooled and solidified, stress, which is responsive to the difference between the coefficients of thermal expansion, will not be applied to the circuit components such as the power-source circuit components 72 and the heat generation component 73, and the electric wires or like connected to the circuit components. As a result, it is possible to prevent breakage of the circuit components such as the power-source circuit components 72 and the heat generation component 73, and disconnection or the like of the electric wires, thus the reliability of the lighting device can be improved.

Moreover, the metal case 6 serving as the reinforcement member is provided in the insulation case 3 for electrically insulating the heat dissipation section 2 and the base 4 from each other; thus, for example, in the event that the lighting device is dropped by mistake and a force is applied to the insulation case 3, deformation of the insulation case 3 can be prevented.

Besides, the metal case 6 is provided in the insulation case 3 so as to cover the inner peripheral surface of the insulation case 3 as mentioned above; hence, even when heat is generated due to failure or the like of the circuit components such as the power-source circuit components 72 and the heat generation component 73 accommodated in the lighting device, it is difficult for the heat emitted from the circuit components to transmit to the insulation case 3, thereby preventing smoking or ignition caused by an increase in temperature of the insulation case 3. Further, since the power-source circuit section 7 is accommodated in the cavity defined by the metal case 6 and the heat dissipation section 2 which are made of metal, the surroundings of the power-source circuit section 7 can be covered with the metal members. Thus, it is difficult for heat or fire caused by the circuit components to transmit to the insulation case 3, thereby preventing smoking or ignition caused by an increase in temperature of the insulation case 3. As a result, the reliability of the lighting device can be further improved.

Furthermore, since the ribs 35 and 37 serving as the retaining sections for retaining the metal case 6 project from the inner surface of the insulation case 3, an area of contact of the insulation case 3 with the metal case 6 can be reduced, and in addition, the gas layer such as air can be interposed between the inner surface of the insulation case 3 and the metal case 6. The interposition of the gas layer allows the gas layer to function as a heat insulator. Therefore, it is more difficult for heat to transmit to the insulation case 3 from the metal case 6. As a result, when heat is generated due to failure or the like of the circuit components such as the power-source circuit components 72 and the heat generation component 73 accommodated in the lighting device, an amount of heat transmitted to the insulation case 3 can be reduced, and smoking or ignition caused by an increase in temperature of the insulation case 3 can be prevented with more reliability. Consequently, the reliability of the lighting device can be further improved.

Moreover, the power-source board 71 is partially engaged with: the engagement concaves 36 provided at the end of the heat-dissipation-section retaining cylinder 31 of the insulation case 3; and the engagement concaves 63 provided at the end of the cylindrical portion 61 of the metal case 6; thus, the power-source circuit section 7 allows the metal case 6 to be retained in an immovable manner between the insulation case 3 and the power-source board 71. As a result, when the lighting device is moved, the metal case 6 does not move in the lighting device and thus a user will not feel a sense of discomfort.

Further, the thermosetting resin 5 is used as the reinforcement material for reinforcing the base 4; thus, the inside of the base 4 can be easily filled with the reinforcement material so that there is no gap in the base 4, and the strength of the base 4 can be further increased.

Note that in the present embodiment described above, the thermosetting resin 5 is used as the reinforcement material with which the inside of the base 4 is filled; however, any reinforcement material may be used as long as it can reinforce the base 4, and light-curing resin or adhesive, for example, may be used. The reinforcement material is preferably a material that has fluidity at the time of filling and is hardened after the filling. Besides, the reinforcement material is preferably a material having high flame resistance equivalent to grade VO of UL (Underwriters Laboratories Incorporated) standards in the U.S.

Further, it is conceivable that a material having high heat conductivity may be used as the reinforcement material. Thus, heat emitted from the power-source circuit section 7 can also be dissipated from the base 4.

Furthermore, in the present embodiment described above, the metal case 6 made of metal is used as the reinforcement member, but any reinforcement member may be used as long as it is made of a material capable of preventing deformation and spread of flame of the insulation case 3 or a material having desired strength and flame resistance. The reinforcement member may be made of aluminum or nonwoven fabric, for example.

Moreover, in the present embodiment described above, the ribs 35 and 37 serving as the retaining sections are provided at the inner surface of the insulation case 3, but the shapes of the retaining sections are not limited to those described in the present embodiment. The retaining sections may have any shapes as long as the gas layer is interposed between the insulation case 3 and the metal case 6 while the contact area between the insulation case 3 and the metal case 6 is reduced. For example, a plurality of cylindrical columnar or rectangular columnar projecting portions may project from the insulation case 3 in a radial direction of the insulation case 3. Although the ribs 35 and 37 are formed along the longitudinal direction of the insulation case 3, the ribs 35 and 37 may be formed along the circumferential direction of the insulation case 3 or may be formed in a spiral manner.

Besides, in the present embodiment described above, the heat dissipation section 2 is configured so that the insulation case 3 is fitted into the heat dissipation section 2, but the heat dissipation section 2 may be configured so that the metal case 6 is fitted into the heat dissipation section 2. In that case, for example, the end of the heat dissipation cylinder 22 of the heat dissipation section 2 may project radially inward, and a groove into which the metal case 6 is to be fitted may be formed at the projecting portion. When the heat dissipation section 2 is configured so that the metal case 6 is fitted into the heat dissipation section 2 in this manner, the power-source circuit section 7 can be accommodated in the cavity defined by the metal case 6 and the heat dissipation section 2 which are made of metal. As a result, the safety and reliability of the lighting device can be improved.

Further, in the present embodiment described above, the lighting device using the LEDs as the light source has been illustrated, but the light source is not limited to the LEDs; alternatively, a light source such as an incandescent light bulb or a fluorescent lamp may be used, or an EL (electroluminescence) light source may be used.

Moreover, in the present embodiment described above, the lighting device to be attached to a bulb socket has been exemplarily described, but the structure for enhancing the strength of the base as described above is not limited to the foregoing lighting device. It is to be noted that the structure for enhancing the strength of the base as described above is also applicable to other types of lighting devices; besides, the present invention may be implemented in various modes in which changes are made within the scope of the claims.

Explanation of the Reference Numerals
1 light source module (light source)
2 heat dissipation section (main body)
3 insulation case (insulator)
35, 37 rib (retaining section)
36 engagement concave
4 base
5 thermosetting resin (resin, hardening resin)
6 metal case (reinforcement member)
63 engagement concave
7 power-source circuit section (drive circuit section)
71 power-source board (board)
72 power-source circuit component (circuit component)
73 heat generation component (circuit component)

1-5. (canceled)

6. A lighting device comprising:
a light source;
a main body accommodating a drive circuit section for driving the light source; and
a base provided on a part of the main body,
wherein a cavity is formed in each of the main body and the base, and
at least the cavity of the base is filled with a resin so that a gas layer exists around a circuit component of the drive circuit section.

7. The lighting device according to claim 6,
wherein the resin is a hardening resin.

8. The lighting device according to claim 6,
further comprising an insulator for electrically insulating the main body and the base from each other,
wherein a reinforcement member is provided in the insulator.

9. The lighting device according to claim 8,
wherein a retaining section for retaining the reinforcement member projects from an inner side of the insulator.

10. The lighting device according to claim 8,
wherein the drive circuit section comprises a board on which the circuit component is mounted, and
the insulator and the reinforcement member are each provided with an engagement concave for engaging with a part of the board.

11. The lighting device according to claim 8,
wherein the reinforcement member has a bottomed cylindrical shape, and is provided at a bottom thereof with a hole through which an electric wire for connecting the drive circuit section to the base is inserted, and
a part of the electric wire corresponding to the hole is covered with a protection tube.

12. The lighting device according to claim 6,
wherein the light source is mounted on the main body, and the main body dissipates heat emitted from the light source.

13. The lighting device according to claim 6,
wherein the light source is an LED.
